(19) United States
(12) Patent Application Publication
(10) Pub. No.: US 2023/0177115 A1
(43) Pub. Date: Jun. 8, 2023

(54) ENHANCING SYNERGY BETWEEN MACHINE LEARNING MODELS AND ANNOTATORS

(71) Applicant: INTERNATIONAL BUSINESS MACHINES CORPORATION, Armonk, NY (US)

(72) Inventors: Pierpaolo TOMMASI, Dublin (IE); Charles Arthur JOCHIM, Dublin (IE); Stephane DEPARIS, Dublin (IE); Debasis GANGULY, Dublin (IE)

(73) Assignee: INTERNATIONAL BUSINESS MACHINES CORPORATION, Armonk, NY (US)

(21) Appl. No.: 17/643,309

(22) Filed: Dec. 8, 2021

(51) Int. Cl. G06K 9/62; G06N 20/00

(52) U.S. Cl. CPC G06K 9/6259; G06K 9/623; G06N 20/00

(57) ABSTRACT

Embodiments facilitating enhanced synergy between machine learning models and annotators in a computing environment by a processor. Annotation tasks may be coordinated between one or more annotators and machine learning models based on one or more annotator preferences and data annotation requirements of a machine learning model. The one or more annotator preferences and the data annotation requirements for coordinating the annotation tasks may be learned over a period of time.

### BACKGROUND OF THE INVENTION

### Field of the Invention

The present invention relates in general to computing systems, and more particularly, to various embodiments for enhancing synergy between machine learning models and annotators in concurrent labeled dataset creations in a computing environment using a computing processor.

### Description of the Related Art

In today's society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure. IoT devices may be embedded in a variety of physical devices or products for assisting in improvements to the quality of life and appropriate living accommodations.

### SUMMARY OF THE INVENTION

Various embodiments for facilitating enhanced synergy between machine learning models and annotators in a computing environment by a processor, are provided. In one embodiment, by way of example only, a method for facilitating enhanced synergy between machine learning models and annotators in a computing environment, again by a processor, is provided. Annotation tasks may be coordinated between one or more annotators and machine learning models based on one or more annotator preferences and data annotation requirements of a machine learning model. The one or more annotator preferences and the data annotation requirements for coordinating the annotation tasks may be learned over a period of time.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5 is block diagram depicting an exemplary user interface for enhancing synergy between machine learning models and annotators in concurrent labeled dataset creations in which aspects of the present invention may be realized.

FIG. 6 is block diagram depicting an exemplary operations for enhancing synergy between machine learning models and annotators in concurrent labeled dataset creations in which aspects of the present invention may be realized.

FIG. 7 is a flowchart diagram depicting an exemplary method for enhancing synergy between machine learning models and annotators in concurrent labeled dataset creations in a computing environment by a processor, again in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular datasets and use the generalizations to solve associated problems by, for example, classifying new data. Once a machine learns generalizations from (or is trained using) known properties from the input or training data, it can apply the generalizations to future data to predict unknown properties.

Moreover, machine learning is a form of AI that enables a system to learn from data rather than through explicit programming. A major focus of machine learning research is to automatically learn to recognize complex patterns and make intelligent decisions based on data, and more efficiently train machine learning models and pipelines. However, machine learning is not a simple process. As the algorithms ingest training data, it is then possible to produce more precise models based on that data. A machine-learning model is the output generated when a machine-learning algorithm is trained with data. After training, input is provided to the machine learning model which then generates an output. For example, a predictive algorithm may create a predictive model. Then, the predictive model is provided with data and a prediction is then generated (e.g., “output”) based on the data that trained the model.

Machine learning enables machine learning models to train on datasets before being deployed. Some machine-learning models are online and continuous. This iterative process of online models leads to an improvement in the types of associations made between data elements. Different conventional techniques exist to create machine learning models and neural network models. The basic prerequisites across existing approaches include having a dataset, as well as basic knowledge of machine learning model synthesis, neural network architecture synthesis and coding skills.

In one aspect, machine learning studies how to construct algorithms and systems that predict a quantity (e.g., a label) from observed examples for a specific problem and domain, using data illustrative of the same problem for the same domain. Labels can be categorical, that is, they can belong to a finite or countable set, or numeric, for example, a score. Probabilistic classifiers can also associate a probability value with the predicted label, denoting the confidence in the prediction, or produce a probability value for each of the possible labels.

Machine learning studies learning algorithms—algorithms that take as input collections of digital representations of examples and their labels and produce a function that predict labels from digital representations of examples. A pair comprising an observation with its label is called a training example, a training sample, or a training instance, and a collection of training examples is called a training set. In natural language processing, training sets for specific problems are typically produced manually by humans (annotators), who inspect and label (annotate) collections of text passages or documents.

Annotation is an inherently noisy process: not only do different annotators often produce different annotations of the same document fragment, but each annotator can produce inconsistent annotations. Annotation mistakes have different causes, such as distraction and fatigue or ambiguous descriptions of the annotation task. Furthermore, the fact that the description of the annotation task is perforce underspecified can cause annotators to make mistakes.

In current approaches and known solutions, there is a static association between different machine learning/artificial intelligence and annotators. Annotators are presented with a list of unlabeled data without much freedom or knowledge of the backend. In contrast, the present invention seeks to improve the synergy between annotators and the machine learning/artificial intelligence operations, since with the static associations there is knowledge that will be lost.

Also, the present invention seeks to assist the annotators (e.g., a machine learning model annotator or human annotator) is selecting or picking as the most appropriate, best, optimal, or maximized annotations based on a mix of their criteria without losing the global focus of the machine learning/artificial intelligence operations. For example, “best” annotations is based on annotator's current priorities (e.g., deadlines to be met), expertise, or any custom defined filter/sorting.

Also, the present invention seeks to provide annotators with tools to re-order/filter the annotations the annotators has been assigned to. Thus, one or more queues of annotations may be created, and an annotator is enabled to select and choose those of the annotations most appropriate, best, optimal, or maximized for achieving the goals and requirements of the annotators. In one aspect, the operation/process of creating queues may be referred to herein as “strategy.” Strategies may be tailored to the annotator (e.g., using a machine learning model) or system.

To summarize, the same set of unlabeled data may be shown to the annotator in different queues, where each queue is generated by a strategy that the annotator could tune. When creating a strategy, the present invention seeks to exploit and use: 1) an annotator context (e.g., area of expertise, calendar, to-do list if available, deadlines and/priorities) to create ranked/filtered queues tailored to him (e.g., focus on this task, focus in completing the closest deadlines).

The present invention seeks to also exploit and use: 1) an annotator feedback (e.g., in an animal classification, the annotator usually picks annotation about dogs, wastes more time classifying cats, and wrongly recognizes quokkas, etc.).

In order to suggest tailored sorting/filtering strategies, currently, when multiple machine learning/artificial intelligence (“ML/AI”) are running in the backend, without the operations of the present invention, there would be little synergy between annotator and a computing backend (e.g., the company the annotator works for): a) either the backend has its own logic to prioritize the missing annotation (e.g. output of an algorithm, or a manual selection), which are then presented to the user as a unified list.

Also, the annotator has multiple lists of annotations, each belonging to a machine learning model. Thus, overloading the annotator with the responsibility of switching between lists and keeping track of priorities (which is an added burden if different lists have different priorities) is challenging and difficult. Accordingly, the present invention facilitates increased coordination or “synergy” between machine learning operations and annotators, providing simultaneous control to both the machine learning operation and annotators.

Accordingly, the present invention provides for facilitating enhanced synergy between machine learning models and annotators in a computing environment. In some implementations, annotation tasks may be coordinated between one or more annotators and machine learning models based on one or more annotator preferences and data annotation requirements of a machine learning model. The one or more annotator preferences and the data annotation requirements for coordinating the annotation tasks may be learned over a period of time.

In other implementations, the present invention provides for facilitating enhanced synergy between machine learning models and annotators by searching for the best data both for the annotator (thereby easing a cognitive load of the annotator) and for creating a better more robust machine learning model (e.g., using active learning). A strategy learner and strategy queue selector searches and identifies parameters and requirements both from the annotator and from a data provider and matches annotators to appropriate data while selecting the best data (instances) for the annotator. In this way, both data producers and data consumers are satisfied, and the process results in an increased machine learning model.

To further illustrate, consider the follow examples.

In a first example, assume an annotator in a use-case about agriculture. There are two classes to identify: fruits and vegetables. Here some missing annotations from the same input dataset. A first machine learning operations (“ML/AL 1”) requests information from the annotator about: banana, avocado, kiwi, tomato. A second machine learning operations (“ML/AL 2”) requests information from the annotator about: cucumber, tomato, onion, potato. Assume an annotator wants to annotate as many as possible but is extremely busy. Without the illustrated embodiments, as describe herein, the annotator would determine the annotator's priorities on which annotations to do first, manually switching ML/AL output lists, and selecting/picking item from a single list at a time.

In contrast, the present invention provides increase synergy between the annotator and the machine learning operation by presenting the annotator with “queues” that the annotator would select from. A queue may be balanced, so it would interleave the unlabeled data. A queue may rank items higher based on the priorities, requirements, and/or needs learned or received from the annotator. Thus, for example, “vegetables” may be identified as a priority and are prioritized. The annotator may the focus on annotating “onions” while the present invention also prioritizes tomatoes.

In another example, assume the annotator is applied to the healthcare field. Assume the annotator is focusing on three particular diseases (e.g., disease 1 (diabetes), disease 2 (chronic heart failure “CHF”), and disease 3 (chronic obstructive pulmonary disease “COPD”). Assume the annotator, representing a health care facility, excels on research/studies for diabetes studies and performs the research/studies without any research deadlines, but the CHF research/studies belong to a project that has a closer deadline. Without the illustrated embodiments, as describe herein, the annotator would manually switch ML/AL output lists and lose critical time and the number of ML/AL operations are restricted from increasing/growing.

In contrast, the present invention provides increase synergy between the annotator and the machine learning operation by dynamically switching tasks for the annotator and prioritize, sort and filter the missing annotations in a unified view thereby enabling the health care facility to benefit from being able to dynamically adjust priorities. The health care facility may then push for increase CHF annotations, which are then passed to the annotator transparently. In this way, the number of ML/AL operations can scale and grow, without limitations, since they are dynamically taken care of. If more disease items are to be classified, it will be easy both for the health care facility and the annotators to scale up. The present invention would create strategies tailored to the annotators and the health care facility. The present invention would also learn the annotator's area of expertise and weigh that one more, learn the annotator is faster and more efficient in some areas of focus while learning of other areas of less understanding and accuracy that has a high error rate (e.g., higher annotation errors) as compared to other fields of study/expertise.

Thus, various embodiments described herein provide for coordinating annotation tasks between annotators, machine learning operations, and data providers by organizing annotation tasks based on the preferences of annotators and the needs of the data providers, which may be learned over time to ease coordination. The present invention provides for a multitude of data instance selectors, each instance requiring annotations for a given machine learning. Each instance provides as output an unlabeled dataset to be annotated for their learning goal. A data instance collector component is enabled to collect all the requests from a data instance selector. A strategy queue selector component is provided to select, provide, and display annotations to the annotator that are ranked as per different criteria. The different criteria may be learned by machine learning, defined by a data provider, or customized/tailored to the annotators based on a strategy learner component. The strategy learner component monitors annotator activities and context (such as calendar, assigned task, completion time, etc.) to optimize the ranking of the missing annotation based on current context and annotator preferences.

In some implementations, the present invention provides to facilitate data exploration of probabilistic models results through an interactive visualization, which displays the most relevant information about several cases in one single self-contained view. Such view uses artificial intelligence to assist a user in gaining access to all the most relevant information displayed at all times thereby removing the need to switch to other views or between different cases.

In some implementation, the present invention may use, as input, 1) multidimensional datasets that are used to train one or more probabilistic models, and 2) a set of cases (to query probabilistic models), each used as evidence. For each case, each of the dimensions may be ranked according to a degree of relevance associated with the set of instances. That is, the dimensions may be ranked according to a relevancy measure (e.g., highest probability first, output of a reasoning engine, topological information, or other defined parameters).

For each case, the dimensions may be filtered (e.g., display top n-number of dimensions only). The probabilistic information computed for each dimension may be filtered thereby showing/displaying the probabilistic information computed from each dimension and providing the ability to tune the selection by manually discarding or selecting dimensions. Any tuning action or adjustments may be collected as feedback to improve the ranking operations.

In some implementations, an interactive representation of the probabilistic models applied to the multidimensional datasets may be depicted/displayed. The interactive representation may include all the evidence collected for every instance (e.g., for each patient in a group of patients). The interactive representation may include the probabilistic information of the most relevant dimensions, as per the ranking for each instance. In one aspect, optionally, for each case, interactive representation may include further recommendations or insights coming or received from other systems (e.g., received from 3^{rd} party systems). In one aspect, optionally, the interactive representation may depict a recommendation or insights about a shared goal among all the set of instances (e.g., all cases).

In some implementations, the present invention provides for booting and training the probabilistic models. In one aspect, the following set of booting operations may be performed. In one step, multidimensional datasets may be read as input. In an additional step, one or more probabilistic models may be trained of the input multidimensional datasets (e.g., Bayesian network, Markov chain, etc.) either offline or online. In an additional step, optionally, one or more simplified or “reduced” probabilistic models may be generated/built on input multidimensional datasets, if no machine learning is necessary (e.g., independent value distributions) either offline or online. In an additional step, an interactive representation of the multidimensional datasets may be initialized based on the one or more probabilistic models and set of instances (e.g., use cases for a group of persons).

In some implementations, the present invention enables the most relevant dimensions for each set of instances to be visualized along with one or more possible values and probability of occurrence for all the different considered instances. A ranking operation may execute to rank the dimensions on a per case basis and determine and filter the most relevant ones.

In some implementations, the present invention provides for fetching or search for additional contextual data to support the dimensions (e.g., recommendations, stats, read-only data) from external system on a per-case basis (single instance of a set of instances). In some implementations, the present invention provides for provided shared insights obtained by combining/aggregating the results of the different instances and different contexts (e.g., different contextual data).

In some implementations, the present invention provides for interaction with visualization representation. In some implementations, the present invention provides for allowing the user to repetitively specify a constraint on the values of one or more dimensions on one or more instances (e.g., by selecting or deselecting at least one value or range of values for one or more dimensions, or by adding/removing dimensions. In some implementations, the present invention provides for inferring a new probability distribution for the values of each of the dimensions of interest using the probabilistic models and user constraints and updating the interactive representation.

In some implementations, the present invention provides for collecting feedback and using it to improve the ranking operations.

In some implementations, the present invention provides for retrieving of external recommendations and additional insights/contextual data. In some implementations, the present invention provides for fetching and visualizing external data generated using as input the user selection on a per case basis. In some implementations, the present invention provides for updating the data at each user selection update. In some implementations, the present invention provides for visualizing a shared goal between the set of instances (e.g., a shared goal amongst a group of persons such as, for example, a family or co-workers). In some implementations, the present invention provides for aggregating the results of all showcased instance to provide aggregated/shared insights. In some implementations, the present invention provides for updating the insights at each user selection update.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

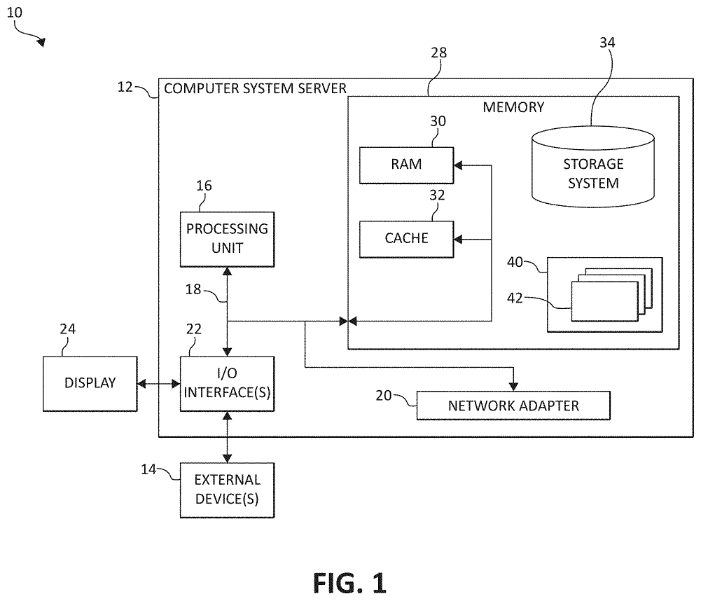

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16 (which may be referred to herein individually and/or collectively as “processor”), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

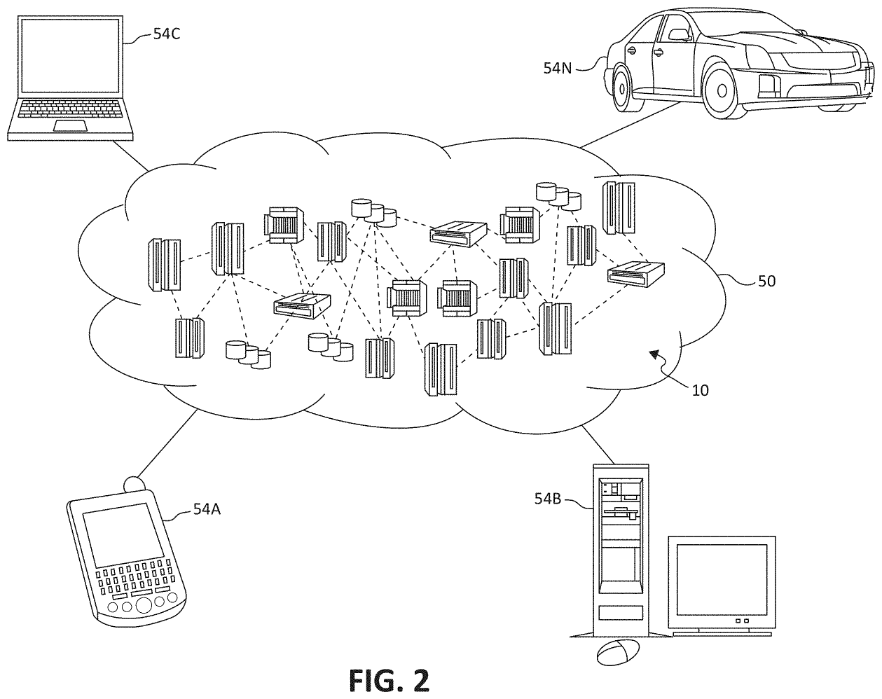

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

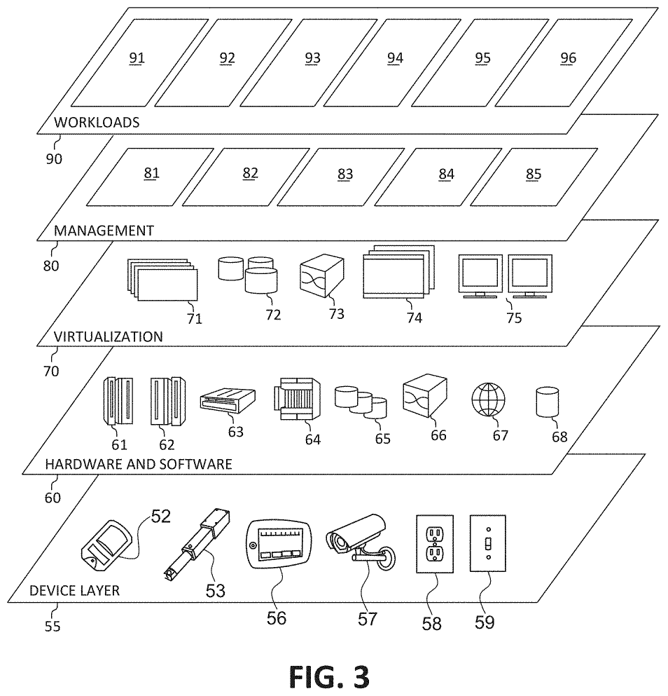

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for facilitating enhanced synergy between machine learning models and annotators s. In addition, workloads and functions 96 for facilitating enhanced synergy between machine learning models and annotators may include such operations as data analysis, machine learning (e.g., artificial intelligence, natural language processing, etc.), user/annotator analysis, operation and/or analysis, as will be further described. One of ordinary skill in the art will appreciate that the workloads and functions 96 for facilitating enhanced synergy between machine learning models and annotators may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides for facilitating enhanced synergy between machine learning models and annotators in a computing environment. Annotation tasks may be coordinated between one or more annotators and machine learning models based on one or more annotator preferences and data annotation requirements of a machine learning model. The one or more annotator preferences and the data annotation requirements for coordinating the annotation tasks may be learned over a period of time.

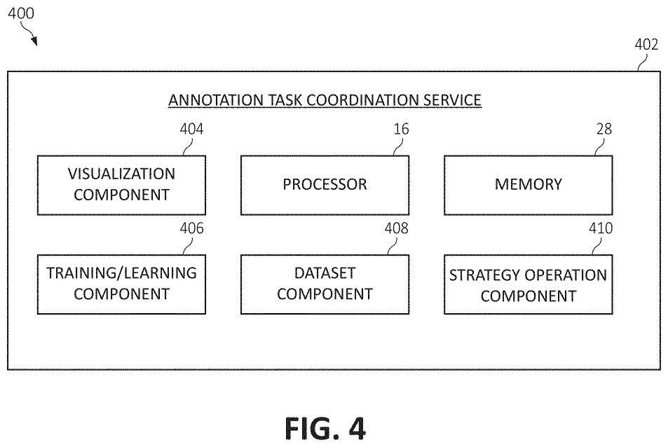

Turning to FIG. 4, a block diagram of various hardware 400 equipped with various functionality as will be further described is shown in which aspects of the mechanisms of the illustrated embodiments may be realized. In one aspect, one or more of the components, modules, services, applications, and/or functions described in FIGS. 1-3 may be used in FIG. 4.

For example, computer system/server 12 of FIG. 1 may be included in FIG. 4 and may be connected to other computing nodes over a distributed computing network, where additional data collection, processing, analytics, and other functionality may be realized. The components of computer system/server 12 may include, but are not limited to, one or more processors or processing units 16 (“processor”) and/or a system memory 28.

The computer system/server 12 of FIG. 1, may include annotation task coordination service 402, along with other related components in order to providing enhanced synergy between machine learning models and annotators. The annotation task coordination service 402 may provide enhanced synergy between machine learning models and annotators.

The annotation task coordination service 402 may include a visualization component 404, a training/learning component 406, a dataset component 408, and a strategy operation component 410.

The dataset component 408 may include and/or receive from an external source (e.g., external to the annotation task coordination service 402) one or more datasets (e.g., data received from a data provider).

The visualization component 404 may receive and use the dataset. The visualization component 404 may read the dataset according to a set of strategy operation parameters and priorities. The visualization component 404, in association with the training/learning component 406, the dataset component 408, and the strategy operation component 410, may coordinate annotation tasks between one or more annotators and machine learning models based on one or more annotator preferences and data annotation requirements of a machine learning model and learn over time the one or more annotator preferences and the data annotation requirements for coordinating the annotation tasks.

The visualization component 404 may provide a visualization and exploration of an interactive representation of one or more queues. That is, the strategy operation component 410, in association with the training/learning component 406 and the dataset component 408, may create one or more annotator queues of unlabeled data of the dataset component 408. The strategy operation component 410, in association with the training/learning component 406 and the dataset component 408, may generate one or more unlabeled data sets requiring one or more of the annotation tasks.

The strategy operation component 410, in association with the training/learning component 406 and the dataset component 408, may rank a plurality of unlabeled data sets requiring one or more of the annotation tasks based on the one or more annotator preferences.

The strategy operation component 410, in association with the training/learning component 406 and the dataset component 408, may provide a queue of unlabeled data sets for the one or more annotators to perform the annotation tasks based on the one or more annotator preferences. The visualization component 404 may provide a visualization of the queue of unlabeled data sets.

The strategy operation component 410, in association with the training/learning component 406 and the dataset component 408, may provide an unlabeled data set in a plurality of queues for the one or more annotators to perform the annotation tasks based on the one or more annotator preferences, wherein each one of the plurality of queues are generated based on an annotation strategy that applies the one or more annotator preferences and a plurality of lists of annotations.

The strategy operation component 410, in association with the training/learning component 406 and the dataset component 408, may generate one or more annotation strategies based on the one or more annotator preferences and the data annotation requirements for annotating an unlabeled data set in one or more queues, wherein the one or more queues are ranked.

The strategy operation component 410, in association with the training/learning component 406 and the dataset component 408, may rank each of a plurality of queues according to a degree of relevance associated with the set of instances where the ranking indicates those of the plurality of dimensions that are included in the interactive representation for visualization and exploration. The strategy operation component 410 may assist the visualization component 404 for providing visualization and exploration of an interactive representation of one or more queues.

It should be noted, that in one embodiment, by way of example only, the training/learning component 406 may perform a machine learning operation that may include, for example, an instance of IBM® Watson® such as Watson® Analytics (IBM® and Watson® are trademarks of International Business Machines Corporation). By way of example only, the training/learning component 406 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting.

Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

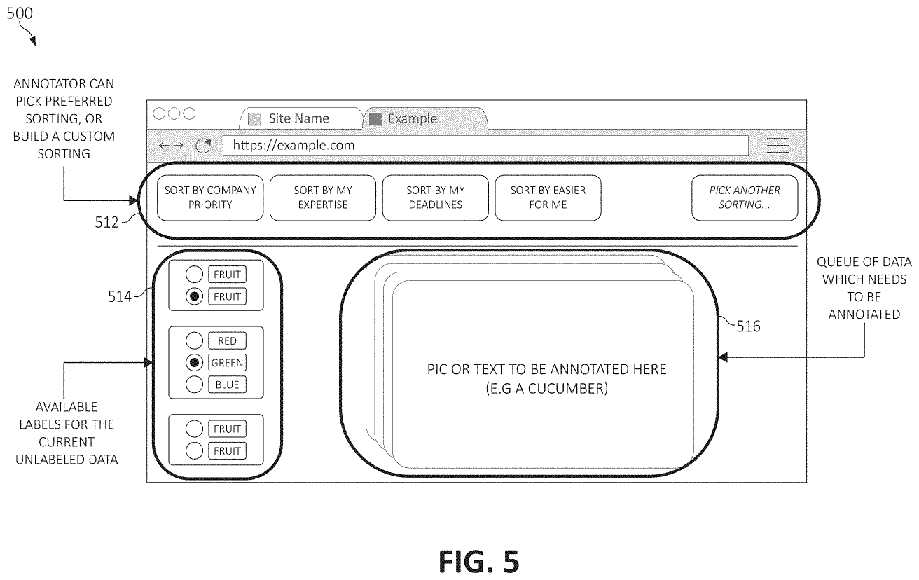

Turning now to FIG. 5, block diagram of exemplary interactive user interface (“UP”) 500 providing visualization and exploration of annotator tasks and queue in a computing environment.

As depicted, the UI 500 provides visualization of annotation tasks that are coordinated between one or more annotators and machine learning models based on one or more annotator preferences and data annotation requirements of a machine learning model, where the annotator preferences and the data annotation requirements for coordinating the annotation tasks may be learned over a period of time.

The UI 500 depicts and provides one or more queues 516 depicting a queue of data, which needs to be annotated such as, for example, images or text data that need to be annotated (e.g., picture of a cucumber). The UI 500 depicts and provides various annotation tasks 512 that may be selected and “picked” based on preferences, priority, or other needs. The annotation tasks 512 may be selected by the annotator and sorted based on a preference or even a customized, built sorting operation. For example, the annotation tasks 512 may include sorting by priority, expertise, deadlines, sorting according to preferences of the annotator, and/or another option for picking another sorting option. Also, the UI 500 depicts and provides various labels (e.g., fruit, red, green, blue, etc.) that are available for the currently selected unlabeled data (e.g., cucumber), which may be displayed in the queues 516.

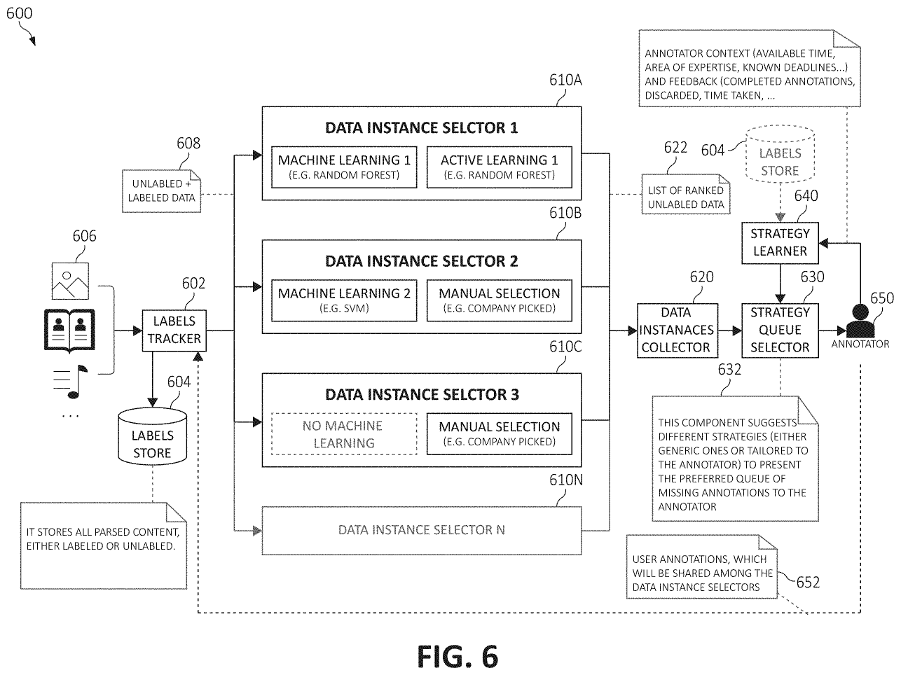

Turning now to FIG. 6, a block diagram 600 depicts exemplary operations for enhancing synergy between machine learning models and annotators in concurrent labeled dataset creations. In one aspect, one or more of the components, modules, services, applications, and/or functions described in FIGS. 1-5 may be used in FIG. 6. Repetitive description of like elements employed in other embodiments described herein is omitted for sake of brevity.

Starting in blocks 610A-N, multiple data instance selectors 610A-N (e.g., data instance selector 1, 2, 3, and N) may receive data 608 (e.g., unlabeled and labeled data) from one or more data providers 606. Each of the data instance selectors 610A-N may include or use similar or different machine learning operations (e.g., machine learning operations 1, 2, or no machine learning) and active learning operations or manual selection for labels and annotation tasks associated with annotating the data 608.

A label tracker 602 may be used to track labels of data and store labels in a label store 604. That is, the label store 604 stores all parsed content, either labeled or unlabeled.

In some implementations, each of the data instance selectors 610A-N require annotations for a given machine learning operation. Each data instance selectors 610A-N provides as output an unlabeled dataset along with a level of priority to be annotated for their learning goal. That is, each data instance selectors 610A-N provides the unlabeled dataset together with the “priority” and ranking. The data instance selectors 610A-N gives a list of unlabeled data along with a degree of importance and priority the data instance selectors 610A-N want it labeled (e.g., for a data instance selector “diabetes” is more important than “pain”, thus would the ranking for “diabetes” is higher than “pain”).

A data instance collector 620 is enabled to collect all the requests from each of the data instance selectors 610A-N. Also, the data instance selectors 610A-N may provide a list of ranked unlabeled data 622. The ranking may apply at different levels and the ranked unlabeled data 622 indicated that a machine learning operations desire or wishes that some of the unlabeled data is to be labeled prior to other unlabeled data (e.g., the machine learning wants some labels more than others). Thus, the ranked unlabeled data 622 indicates an order for labeling unlabeled data.

The data instance selectors 610A-N provide machine learning models (using annotated data) to search for the best data both for the annotator (thereby easing a cognitive load of the annotator) and for creating a better more robust machine learning model (e.g., using active learning). However, if the data is unlabeled, the data instance selectors 610A-N generate a list of unlabeled data that require annotations from the annotator 450 for retraining, building, or adjusting a machine learning model.

In some implementations, the data instance selectors 610A-N may be considered as a voter amongst the other data instance selectors 610A-N. The data instance selectors 610A-N may vote and create a ranked list of items to annotate the ranked list of unlabeled data to annotate is their preferences list. The objective is then to aggregate all the ranked list in one ranking. One or more preferences (e.g., annotator 650 preferences) are described using multiple attributes such as, for example: 1) a required annotation time for the user, 2) criticality of the info (disambiguation power, e.g., increase in accuracy or precision or F1), 3) a business priority (would have a veto), 4) a novelty/diversity of an annotation batch, 4) an alignment with the expertise of the annotator 650, and other attributes, priorities, or requirements. Each ranking operation may be scored/described along each of these attributes. The preferences of the annotator 650 may be used to determine the best aggregation method/operation for the annotator 650. That is, the aggregation preferences of the annotator 650 may be learned or receive as instruction from the annotator 650 and then be used and displayed to represent a utility function of the annotator 650.

A preferences disaggregation may be learned where the preferences of the annotator 650 are learned in the background (e.g., the weights and the veto threshold), using a feedback loop. After enough examples, the data instance selectors 610A-N (in association with a strategy queue selector 630) may can recommend a master list of annotation items to the annotator 650. The annotator 650 is free to follow it as is, or to produce his/her own ranking (the system then learns and adjusts).

More specifically, the strategy queue selector 630 is provided to select, provide, and display annotations to the annotator 650 that are ranked as per different criteria. The different criteria may be learned by machine learning, defined by a data provider, or customized/tailored to the annotators based on a strategy learner component. The strategy queue selector 630 monitors annotator activities and context (such as, for example, calendars, assigned tasks, completion time, etc.) to optimize the ranking of the missing annotation (e.g., the list of ranked unlabeled data 622) based on current context and preferences of the annotator 650.

The strategy queue selector 630 may suggests different annotation strategies (either generic or predefined strategies or customized/tailored annotation strategies) to the annotator 650 to present a preferred queue of unlabeled data to the annotator 650 (e.g., preferred queue of missing annotations).

In some implementations, the strategy queue selector 630 may display multiple lists of items (e.g., a queue of annotation task) corresponding to different system suggested lists of instances that the annotator 650 can choose to proceed with.

Each such list or queue shows the system's estimated time of completion, which would allow the annotator 650 to choose a specific strategy (e.g., shortest job first or longest job first, company priority first, closest deadlines first, tailored to the annotator's 650 expertise.

The strategy queue selector 630 may use the currently trained model of the data instance selectors 610A-N to predict a class of the instances in each list. These predictions are summarized as a system-estimated class distribution to the annotator 650. This gives the annotator 650 flexibility in choosing a queue as per the annotator's 650 current preference (e.g., if the annotator 650 had been mostly annotating images for tomatoes in the past hour, then probably the annotator 650 may want to complete all the tomatoes to maintain the current flow). Alternatively, the annotator 650 may become fatigued by and wants to move on to another annotation task to label such as, for example, bananas and hence the annotator 650 selects a queue with more bananas in it). Also, the annotator 650 may select instances from different queues and making his own customized list of instances that the annotator 650 may desire to annotate. In one aspect, the strategy queue selector 630 may enable and provide for a drag-and-drop option from the queues into ones ‘add-to-cart’ queue.

A strategy learner 640 and strategy queue selector 630 searches and identifies parameters and requirements both from the annotator 650 and from a data provider 606 and matches and provides to the annotator 650 the appropriate data, while selecting the best data (instances) for the annotator 650. In this way, both data producers and data consumers are satisfied, and the process results in an increased machine learning model.

The strategy learner 640 may learn the annotator context of the annotator 650 such as, for example, calendar data of the annotator 650, area of expertise of the annotator 650, known deadlines of the annotator 650, and feedback of the of the annotator 650) along with completed annotations, discarded, time taken, or other activities associated with the annotating operations of the annotator 650.

In some implementations, the strategy learner 640 maintains and keeps track of the following information: 1) the time taken by the annotator 650 to label a data instance (e.g., image); 2) previous preference of the annotator 650 in terms of selecting data instances for annotation; and/or 3) annotator 650 context (e.g., task, expertise, deadline that need to be met by the annotator 650, calendaring data, etc. The strategy learner 640 may rank the data instances with the objective of: 1) the data instances that the annotator 650 would be able to finish off within a given amount of time (e.g., if the annotator 450 has a 15 mins slot in the calendar (which is synced with the system), the system prioritizes those instances with which the user is more expert in or prefers). The strategy learner 640 may also takes into account the annotator's 650 own preferences if that does not conflict with time constraints on the calendar of the annotator 650 (e.g., even if the annotator 650 takes more time annotating certain classes of data instances, if that's something which he has done the most in recent history, it would be good from the system point-of-view to push these instances to the annotator 650.).

The annotated data 650 (e.g., labeled data) may then be fed back to the label tracker 602 and used by the data instance selectors 610A-N. Again, the label store 604 may store the annotated data labels, which may include storing all parsed data content, both labeled (e.g., data annotated and labeled by the annotator 650 and unlabeled data from a data provider 606).

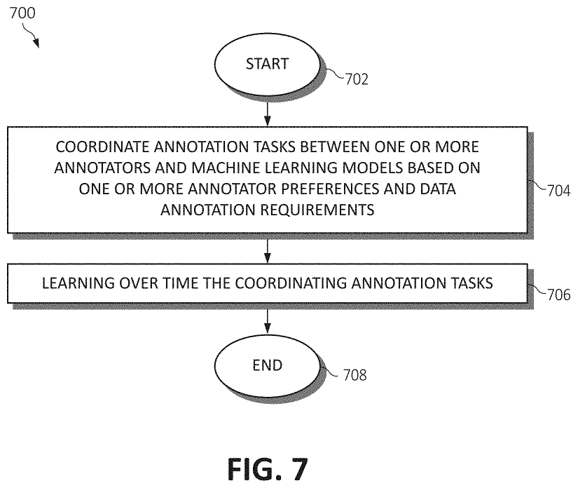

Turning now to FIG. 7, a method 700 for enhancing synergy between machine learning models and annotators in concurrent labeled dataset creations in a computing environment is depicted. The functionality 700 may be implemented as a method executed as instructions on a machine, where the instructions are included on at least one computer readable medium or on a non-transitory machine-readable storage medium. The functionality 700 may start in block 702.

Annotation tasks may be coordinated between one or more annotators and machine learning models based on one or more annotator preferences and data annotation requirements of a machine learning model, as in claim 704. The one or more annotator preferences and the data annotation requirements for coordinating the annotation tasks may be learned over time (e.g., a defined or selected period of time), as in block 706. The functionality 700 may end in block 708.

In one aspect, in conjunction with and/or as part of at least one block of FIG. 7, the operations of method 700 may include each of the following. The operations of method 700 may create one or more annotator queues of the annotation tasks. The operations of method 700 may generate one or more unlabeled data sets requiring one or more of the annotation tasks. The operations of method 700 may rank a plurality of unlabeled data sets requiring one or more of the annotation tasks based on the one or more annotator preferences.

The operations of method 700 may provide a queue of unlabeled data sets for the one or more annotators to perform the annotation tasks based on the one or more annotator preferences.

The operations of method 700 may provide an unlabeled data set in a plurality of queues for the one or more annotators to perform the annotation tasks based on the one or more annotator preferences, wherein each one of the plurality of queues are generated based on an annotation strategy that applies the one or more annotator preferences and a plurality of lists of annotations.

The operations of method 700 may generate one or more annotation strategies based on the one or more annotator preferences and the data annotation requirements for annotating an unlabeled data set in one or more queues, wherein the one or more queues are ranked.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for facilitating enhanced synergy between machine learning models and annotators in a computing environment, comprising:
coordinating annotation tasks between one or more annotators and machine learning models based on one or more annotator preferences and data annotation requirements of a machine learning model; and
learning over time the one or more annotator preferences and the data annotation requirements for coordinating the annotation tasks.

2. The method of claim 1, further including creating one or more annotator queues of unlabeled data.

3. The method of claim 1, further including generating one or more unlabeled data sets requiring one or more of the annotation tasks.

4. The method of claim 1, further including ranking a plurality of unlabeled data sets requiring one or more of the annotation tasks based on the one or more annotator preferences.

5. The method of claim 1, further including providing a queue of unlabeled data sets for the one or more annotators to perform the annotation tasks based on the one or more annotator preferences.

6. The method of claim 1, further including providing an unlabeled data set in a plurality of queues for the one or more annotators to perform the annotation tasks based on the one or more annotator preferences, wherein each one of the plurality of queues are generated based on an annotation strategy that applies the one or more annotator preferences and a plurality of lists of annotations.

7. The method of claim 1, further including generating one or more annotation strategies based on the one or more annotator preferences and the data annotation requirements for annotating an unlabeled data set in one or more queues, wherein the one or more queues are ranked.

8. A system for facilitating enhanced synergy between machine learning models and annotators in a computing environment, comprising:
one or more computers with executable instructions that when executed cause the system to:
coordinate annotation tasks between one or more annotators and machine learning models based on one or more annotator preferences and data annotation requirements of a machine learning model; and
learn over time the one or more annotator preferences and the data annotation requirements for coordinating the annotation tasks.

9. The system of claim 8, wherein the executable instructions when executed cause the system to create one or more annotator queues of unlabeled data.

10. The system of claim 8, wherein the executable instructions when executed cause the system to generate one or more unlabeled data sets requiring one or more of the annotation tasks.

11. The system of claim 8, wherein the executable instructions when executed cause the system to rank a plurality of unlabeled data sets requiring one or more of the annotation tasks based on the one or more annotator preferences.

12. The system of claim 8, wherein the executable instructions when executed cause the system to provide a queue of unlabeled data sets for the one or more annotators to perform the annotation tasks based on the one or more annotator preferences.

13. The system of claim 8, wherein the executable instructions when executed cause the system to provide an unlabeled data set in a plurality of queues for the one or more annotators to perform the annotation tasks based on the one or more annotator preferences, wherein each one of the plurality of queues are generated based on an annotation strategy that applies the one or more annotator preferences and a plurality of lists of annotations.

14. The system of claim 8, wherein the executable instructions when executed cause the system to generate one or more annotation strategies based on the one or more annotator preferences and the data annotation requirements for annotating an unlabeled data set in one or more queues, wherein the one or more queues are ranked.

15. A computer program product for facilitating enhanced synergy between machine learning models and annotators in a computing environment, the computer program product comprising:
one or more computer readable storage media, and program instructions collectively stored on the one or more computer readable storage media, the program instruction comprising:
program instructions to coordinate annotation tasks between one or more annotators and machine learning models based on one or more annotator preferences and data annotation requirements of a machine learning model; and
program instructions to learn over time the one or more annotator preferences and the data annotation requirements for coordinating the annotation tasks.

16. The computer program product of claim 15, further including program instructions to create one or more annotator queues of unlabeled data.

17. The computer program product of claim 15, further including program instructions to:
generate one or more unlabeled data sets requiring one or more of the annotation tasks; and
rank a plurality of unlabeled data sets requiring one or more of the annotation tasks based on the one or more annotator preferences.

18. The computer program product of claim 15, further including program instructions to provide a queue of unlabeled data sets for the one or more annotators to perform the annotation tasks based on the one or more annotator preferences.

19. The computer program product of claim 15, further including program instructions to provide an unlabeled data set in a plurality of queues for the one or more annotators to perform the annotation tasks based on the one or more annotator preferences, wherein each one of the plurality of queues are generated based on an annotation strategy that applies the one or more annotator preferences and a plurality of lists of annotations.

20. The computer program product of claim 15, further including program instructions to generate one or more annotation strategies based on the one or more annotator preferences and the data annotation requirements for annotating an unlabeled data set in one or more queues, wherein the one or more queues are ranked.
